(19) United States
(12) Patent Application Publication
(10) Pub. No.: US 2018/0191075 A1
(43) Pub. Date: Jul. 5, 2018

(54) COMPACT MULTI-BAND DUAL SLANT POLARIZATION ANTENNA

(71) Applicant: Radio Frequency Systems, Inc., Meriden, CT (US)

(72) Inventor: Kostyantyn Semonov, Meriden, CT (US)

(21) Appl. No.: 15/395,945

(22) Filed: Dec. 30, 2016

(51) Int. Cl. H01Q 9/06; H01Q 1/48

(52) U.S. Cl. CPC H01Q 9/065; H01Q 1/48

(57) ABSTRACT

A base station antenna includes in one embodiment an antenna ground plane and one or more sub-antenna arrays each having a plurality of a first type of radiating element attached to the ground plane. A spatial diplexer sub-antenna is included having a pedestal coupled to the antenna ground plane adjacent the one or more sub-antenna arrays and having an elevated grounding surface including two lanes. A sub-antenna array having a plurality of a second type of radiating element is attached to the antenna ground plane between the two elevated grounding surface lanes. A sub-antenna array having a plurality of a third type of radiating element is attached to the elevated grounding surface. Each of two of the third type of radiating element is located at a corresponding intersection of the two elevated grounding surface lanes and a third elevated grounding surface lane.

### TECHNICAL FIELD

This application is directed, in general, to base station antennas and, more specifically, but not exclusively, to antennas that accommodate multiple low-frequency bands and multiple high-frequency bands.

### BACKGROUND

This section introduces aspects that may be helpful to facilitating a better understanding of the inventions. Accordingly, the statements of this section are to be read in this light and are not to be understood as admissions about what is in the prior art or what is not in the prior art. Base station antennas employ architectures that usually include a requirement to accommodate multiple signal frequency bands. These may generally be split into the two categories of high frequency bands and low frequency bands, which need to be accommodated by the base station antenna. Of the two, the low frequency bands require more antenna real estate due to having a larger foot print or area of aperture necessitated by their longer wavelengths. Additionally, base stations may split the low band frequencies into two narrower sub-bands and may employ diplexers to accomplish this sub-band frequency splitting, thereby increasing the overall cost of the base station antenna.

What is needed in the art are low-band antenna architectures that provide a reduction in overall base station size without requiring additional devices to accomplish sub-band frequency splitting.

### SUMMARY

Disclosed herein are various embodiments of apparatus and methods that may be beneficially applied to, for example, a spatial diplexer antenna. While such embodiments may be expected to provide improvements in performance and/or reduction of size of such apparatus relative to conventional implementations, no particular result is a requirement of the present invention unless explicitly recited in a particular claim.

In one embodiment, a spatial diplexer antenna, includes a pedestal located on a ground plane, the pedestal including an elevated grounding surface having two lanes. The spatial diplexer antenna also includes at least one antenna element connected to the ground plane between the two lanes and an antenna element connected to the elevated grounding surface at an intersection of a third lane of the elevated grounding surface and one of the two lanes.

In another aspect, a method of manufacturing a base station antenna includes providing an antenna ground plane and constructing on the antenna ground plane a pedestal having an elevated grounding surface including two lanes. The method of manufacturing a base station antenna also includes attaching to the antenna ground plane at least one antenna element between the two lanes and attaching an antenna element to the elevated grounding surface of the pedestal at an intersection of a third lane of the elevated grounding surface and one of the two lanes.

In yet another aspect, a base station antenna includes an antenna ground plane and one or more sub-antenna arrays each comprising a plurality of a first type of antenna element attached to the ground plane. The base station antenna also includes a spatial diplexer sub-antenna having a pedestal that is coupled to the antenna ground plane adjacent the one or more sub-antenna arrays that employs an elevated grounding surface including two lanes. The spatial diplexer sub-antenna also has a sub-antenna array having a plurality of a second type of antenna element attached to the antenna ground plane between the two lanes and a sub-antenna array having a plurality of a third type of antenna element attached to the elevated grounding surface, each of two of the third type of antenna element being located at a corresponding intersection of the two elevated grounding surface lanes and a third elevated grounding surface lane.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

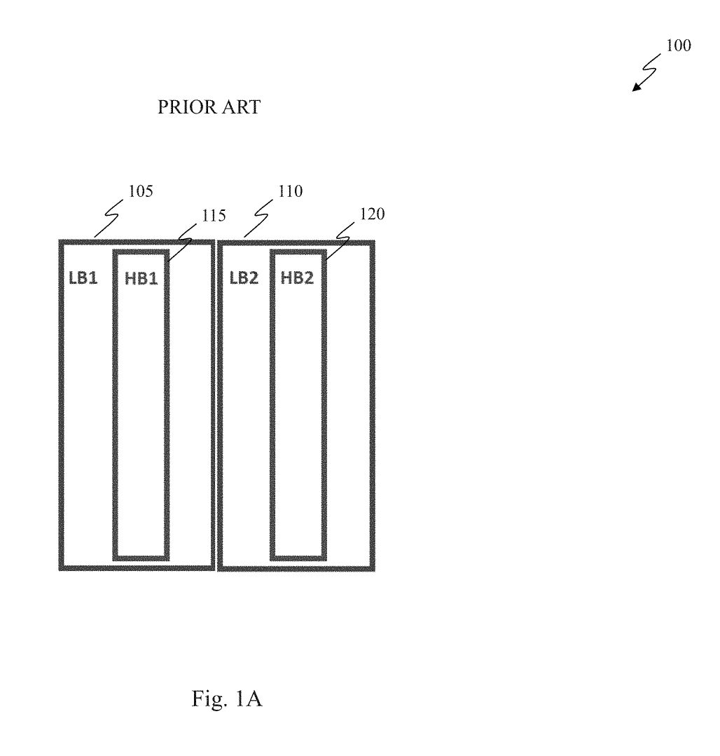

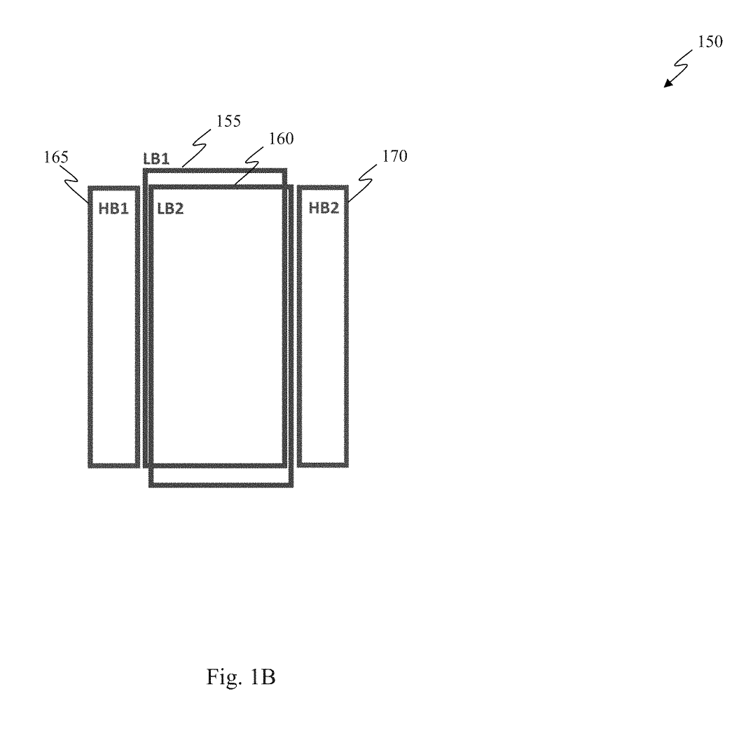

FIGS. 1A and 1B illustrate conceptual areas of aperture for low band and high band sub-antenna arrays, wherein FIG. 1A is representative of some conventional antenna configurations, and FIG. 1B is representative of some embodiments consistent with the disclosure;

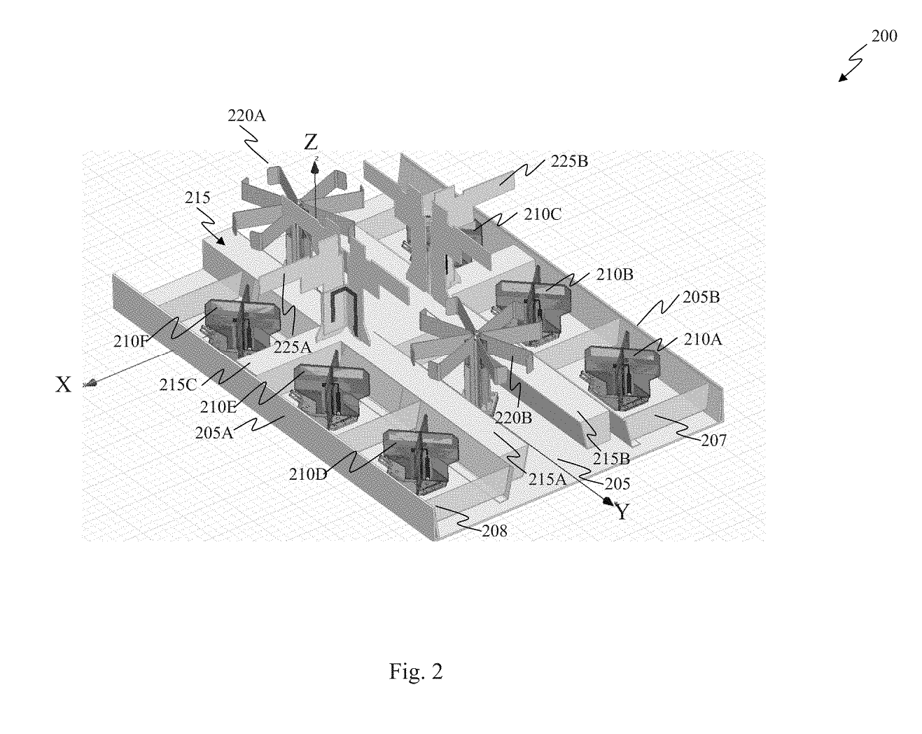

FIG. 2 illustrates a pictorial view of an embodiment of a multi-band base station antenna constructed according to the principles of the present disclosure;

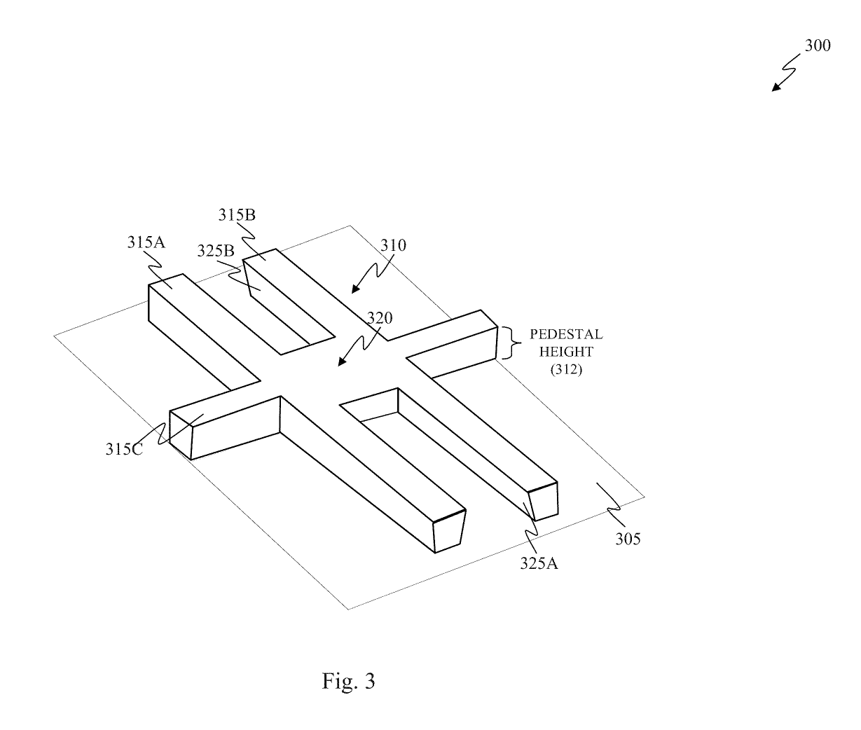

FIG. 3 illustrates a pictorial view of a ground plane arrangement as may be employed in a multi-band base station antenna embodiment such as that of FIG. 2; and

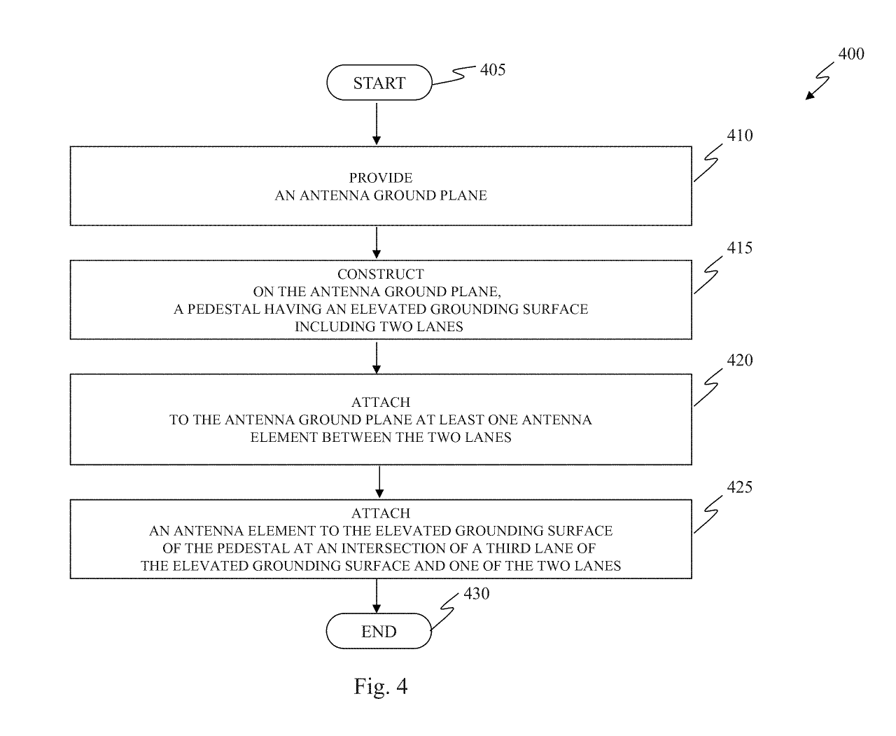

FIG. 4 illustrates a flow diagram of an embodiment of a method of manufacturing a base station antenna carried out according to the principles of the present disclosure.

### DETAILED DESCRIPTION

Some conventional multi-band base station antennas are based on an architecture that shares the same portion of aperture by pairs of low band and high band sub-antenna arrays. In such cases, a distance between low band radiators in an elevation plane (EL-plane) is twice the distance between high band radiators. An azimuth plane (AZ-plane) width of the pair of low band and high band sub-arrays is defined by the requirements of a low band half-power beamwidth value. A minimum width of a low band sub-antenna array is restricted by the type of low band radiator and by the shape of a back plate (ground plane) and back plate (ground plane) walls. For a conventional tetra-band base station antenna, a minimum width of the antenna is limited by double a width of a low band sub-antenna array.

Embodiments of the present disclosure are generally directed to base stations employing multi-band antennas having at least two low band sub-antennas. As used herein, “sub-antenna” refers to nominally identical radiating elements configured to operate at a same frequency band. These embodiments differ from a traditional design in that two low band sub-antennas form a spatial diplexer and share a same or “common area” of antenna aperture. By common area, it is meant that the apertures of each sub-antenna overlap at least partially and preferably substantially. Such operation is achieved by using two different types of low band radiating elements. In one embodiment, a first type employs a pair of dipoles (e.g., dual-slant polarization dipoles), and a second type employs a pair of tripoles. A separating distance between each radiating element pair of each sub-antenna type is proportional to an average period (wavelength) of its frequency band. Additionally, the first and second pairs of radiating elements are positioned orthogonally with respect to one another and offset from one another by half the average period (wavelength). In a first sub-antenna array, radiating elements are located on an antenna ground plane, while in a second sub-antenna array, radiating elements are located on a grounding pedestal (i.e., an elevated ground plane), mounted to the antenna ground plane. In general, it is preferable that the pair of tripoles be positioned with a same height above the antenna ground plane.

Moreover, it is generally preferred that the pedestal include one or more mechanical features that enhance the operation of the tripole radiating elements. For example, the general shape of the pedestal may be designed to result in a desired radiating pattern and radiation performance of the tripoles. Pedestals consistent with the disclosure may be operationally advantageous by providing an appropriate radiating platform for the tripoles. Use of the pedestal may also achieve an advantageous decoupling between the first and second sub-antenna arrays by reducing the mutual coupling between the two and thereby reducing unwanted interference between the first low band sub-antenna and the second low band sub-antenna.

Without limitation, expected advantages provided by embodiments of the present disclosure include a reduction in an overall width of the multi-band antenna and an elimination of some typically expensive additional components that are normally required.

FIG. 1A illustrates conceptual areas of antenna aperture for low band and high band sub-antenna arrays, generally designated 100, 150. The areas of antenna aperture 100 include an example of two low band (LB1, LB2) 105, 110 and two high band (HB1, HB2) 115, 120 antenna apertures, as shown. Conventionally, the apertures associated with different high band sub-antenna arrays do not overlap, and the apertures associated with different low band sub-antenna arrays do not overlap. The illustrated configuration is consistent with conventional practice, and thus the two low band antenna apertures 105, 110 correspond to separate antenna apertures. The total width of an antenna configured as shown may be seen to be determined in part by the low band antenna apertures, that is, the sum of the widths of the two areas of aperture 105, 110.

Referring to FIG. 1B, the areas of antenna aperture 150 include two low band (LB1, LB2) 155, 160 and two high band (HB1, HB2) 165, 170 antenna apertures arranged as shown. Here, the two low band areas of antenna aperture 155, 160 are seen to substantially overlap. Embodiments consistent with the disclosed principles include at least a partial overlap of the low band antenna apertures 155, 160 to provide the described expected benefit. It may be preferable in some embodiments that the low band antenna apertures 155, 160 overlap substantially, e.g. greater than about 75% or completely, (e.g., 100%). Note that in some cases, one of the low band antenna apertures 155, 160 may be smaller than the other, so complete overlap includes the situation in which the smaller low band antenna aperture is located completely within the larger low band antenna aperture. When the low band antenna apertures 155, 160 overlap, the overall antenna width may be advantageously reduced.

FIG. 2 illustrates a pictorial view of an embodiment of a multi-band base station antenna, generally designated 200, constructed according to the principles of the present disclosure. The multi-band base station antenna 200 includes an antenna ground plane 205 employing terminating ground plane structures 205A, 205B and a plurality of high band radiating elements (210A-210F), representing a first type of radiating element, mounted on the ground plane 205. Each of the plurality of high band radiating elements (210A-210F) is surrounded by a shielding extension of the ground plane 205 of which 207 and 208 are typical.

As used herein, the term “radiating element” does not imply that the antenna element is limited to transmission of radio-frequency (RF) signals. Thus any feature referred to herein as a radiating element may be capable of both RF transmission and RF reception, unless otherwise explicitly limited. Moreover, any such radiating element is not implied to be energized and actively radiating, unless explicitly described as doing so.

The multi-band base station antenna 200 also includes a spatial diplexer sub-antenna wherein a pedestal 215 is conductively connected to the ground plane 205 and employs an elevated grounding surface formed into three lanes 215A, 215B, 215C, as shown. The spatial diplexer sub-antenna of the multi-band base station antenna 200 additionally includes a first low band sub-antenna array having dipole radiating elements 220A, 220B, which are sometimes referred to as butterfly dipoles, and is representative of a second type of radiating element employed. A third type of radiating element having tripole radiating elements 225A, 225B is employed as a second low band sub-antenna array in the spatial diplexer sub-antenna.

In the embodiment indicated FIG. 2, the two low band sub-antenna arrays 220A, 220B and 225A, 225B share a same portion of an area of antenna aperture to achieve a reduced overall width for the multi-band base station antenna 200. In this case, radiating elements of both low band sub-antenna arrays are offset along an antenna elevation plane (EL-plane) center line. If an offset distance equal to half of a low band antenna element EL-plane period is employed in a low band sub-antenna array, this condition may cause operational overlapping of both low band sub-frequency arrays when conventional dual-slant polarization radiating antenna elements are employed due to resonance dimensions of the base station antenna.

If antenna radiators are separated by a distance that is close to a half-wavelength, the period of the low band sub-antenna arrays may be limited by conditions of grating lobe appearance in the antenna array. This overlapping issue may be resolved by using pairs of tripole radiating antenna elements fed through a power divider as low band radiating elements in one of the low band sub-antenna arrays. Therefore, the first low band sub-antenna array employs first and second dipole radiating elements 220A, 220B, and the second low band sub-antenna array employs first and second tripole radiating elements 225A, 225B.

The second low band sub-antenna array (radiating elements 225A, 225B) employing the pair of tripoles is located on the pedestal 215, which has a specially tailored or shaped surface for providing a satisfactory isolation level between the first and second low band sub-antenna arrays (radiating elements 220A, 220B and 225A, 225B). In particular, the pedestal 215 includes lanes 215A and 215B that are respectively located between each of the tripole radiating elements 225A, 225B and the ground plane 205. In this embodiment, a pedestal height (illustrated in FIG. 3) of the pedestal 215 above the antenna ground plane 205 may be within a range of about 12 percent to about 18 percent of the separation distance between antenna radiators of the second low band sub-antenna array.

A pedestal height with this range may advantageously provide for termination of electromagnetic fields from the tripole radiating elements before they can interact with high band radiators of a high band sub-antenna array. The specially shaped and tailored pedestal 215 operates as a secondary reflector for the second low band sub-antenna array 225A, 225B employing the pair of tripoles. Providing an appropriate relationship between secondary reflector dimensions satisfies requirements for a radiation pattern half-power beamwidth in the two low band sub-antenna arrays 220A, 220B and 225A, 225B as well as high band sub-antenna arrays for the multi-band base station antenna 200 over its frequency bands. An AZ-plane distance between the pair of tripoles is determined by requirements set forth by a half-power beamwidth of a second low band sub-antenna array radiation pattern.

FIG. 3 illustrates a pictorial view of a ground plane arrangement, generally designated 300, as may be employed in a multi-band base station antenna embodiment such as that of FIG. 2. The ground plane arrangement 300 includes a ground plane 305 and a pedestal 310 having a pedestal height 312. The pedestal 310 includes first, second and third lanes 315A, 315B, 315C wherein the third lane 315C contains a broadened, or widened, third lane portion 320 between the first and second lanes 315A, 315B. The pedestal 310 also includes two inclined side surfaces 325A, 325B that are U-shaped and formed by the intersection of the first and second lanes 315A, 315B and the broadened third lane portion 320. In some embodiments, and as illustrated, the inclined side surfaces 325A, 325B may be configured such that a distance between the two lanes 315A and 315B is greater at the ground plane 305 than at the top surface of the pedestal 320.

Generally, every antenna radiation pattern of an antenna radiating element has a ground plane requirement associated with it, and the pedestal 310 provides management of a complex arrangement of radiating elements while reducing the footprint requirement of a multi-band antenna. In particular, the pedestal 320 provides a required configuration (e.g., height, width and shape) for the proper grounding of two low band sub-antenna arrays while accommodating a plurality of high band sub-antenna arrays.

The pedestal 310 is conductively coupled to the ground plane 305 thereby allowing the first, second and third lanes 315A, 315B, 315C to provide an elevated grounding structure. As previously discussed, a plurality of high band radiating elements may be located on the ground plane outside of the first and second lanes 315A, 315B. Additionally, a first low band sub-antenna array may be located on the ground plane between the first and second lanes 315A, 315B with radiating elements placed on either side of the broadened third lane portion 320 of the third lane 315C.

The elevated grounding structure of the pedestal 310 is tailored to accommodate operational requirements of a second low band sub-antenna array. Therefore, a second low band sub-antenna array may be placed on the third lane 315C and located on either side of the broadened third lane portion 320 thereby making it orthogonally positioned with respect to the first low band sub-antenna array. The two inclined side surfaces 325A, 325B reduce and reflect spurious energy for absorption by the ground plane 305.

Without implied limitation, this arrangement is believed to allow the two low band sub-antenna arrays to be located between the two high band antenna sub-antenna arrays and substantially occupy a same or common area of antenna aperture.

FIG. 4 illustrates a flow diagram of an embodiment of a method of manufacturing a base station antenna, generally designated 400, carried out according to the principles of the present disclosure. The method 400 starts in a step 405 and then an antenna ground plane is provided, in a step 410. A pedestal is constructed on the antenna ground plane having an elevated grounding surface including two lanes, in a step 415. At least one antenna element is attached to the antenna ground plane between the two lanes, in a step 420, and an antenna element is attached to the elevated grounding surface of the pedestal at an intersection of a third lane of the elevated grounding surface and one of the two lanes, in a step 425.

In one embodiment, the two lanes of the elevated grounding surface are about perpendicular to the third lane of the elevated grounding surface. Correspondingly, the elevated grounding surface of the third lane includes a widened third lane elevated grounding surface between the two lanes. In another embodiment, the third lane is positioned midway between two antenna elements connected to the ground plane between the two lanes.

In a further embodiment, a distance of the elevated grounding surface above the ground plane is about 12 to about 18 percent of a separation distance between two antenna elements connected to the elevated grounding surface. In yet another embodiment, the at least one antenna element connected to the ground plane is a first type of antenna element, and further comprising attaching a second type of antenna element to the ground plane, wherein one of the two lanes is located between the first type of antenna element and the second type of antenna element.

In yet a further embodiment, the at least one antenna element includes two dual slant polarization dipole antenna elements, and the antenna element connected to the elevated grounding surface is one of two tripole antenna elements each of which is connected to the elevated grounding surface at an intersection of the third lane and one of the two lanes. The method 400 ends in a step 430.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A spatial diplexer antenna, comprising:
a pedestal located on a ground plane, the pedestal including an elevated grounding surface having two lanes;
at least one antenna element connected to the ground plane between the two lanes; and
an antenna element connected to the elevated grounding surface at an intersection of a third lane of the elevated grounding surface and one of the two lanes.

2. The antenna as recited in claim 1 wherein the third lane is about perpendicular to the two lanes.

3. The antenna as recited in claim 1 wherein the third lane includes a widened elevated grounding surface between the two lanes.

4. The antenna as recited in claim 1 wherein the third lane is positioned midway between two antenna elements connected to the ground plane between the two lanes.

5. The antenna as recited in claim 1 wherein a distance between the elevated grounding surface and ground plane is about 12 to about 18 percent of a separation distance between two antenna elements connected to the elevated grounding surface.

6. The antenna as recited in claim 1 wherein the at least one antenna element connected to the ground plane is a first type of antenna element, and the antenna further comprises a second type of antenna element, wherein one of the two lanes is located between the first type of antenna element and the second type of antenna element.

7. The antenna as recited in claim 1 wherein the at least one antenna element includes two dual slant polarization dipole antenna elements, and the antenna element connected to the elevated grounding surface is one of two tripole antenna elements, each connected to the elevated grounding surface at an intersection of the third lane and one of the two lanes.

8. A method of manufacturing a base station antenna, comprising:
providing an antenna ground plane;
constructing on the antenna ground plane a pedestal having an elevated grounding surface including two lanes;
attaching to the antenna ground plane at least one antenna element between the two lanes; and
attaching an antenna element to the elevated grounding surface of the pedestal at an intersection of a third lane of the elevated grounding surface and one of the two lanes.

9. The method as recited in claim 8 wherein the two lanes of the elevated grounding surface are about perpendicular to the third lane of the elevated grounding surface.

10. The method as recited in claim 8 wherein the elevated grounding surface of the third lane includes a widened third lane elevated grounding surface between the two lanes.

11. The method as recited in claim 8 wherein the third lane is positioned midway between two antenna elements connected to the ground plane between the two lanes.

12. The method as recited in claim 8 wherein a distance of the elevated grounding surface above the ground plane is about 12 to about 18 percent of a separation distance between two antenna elements connected to the elevated grounding surface.

13. The method as recited in claim 8 wherein the at least one antenna element connected to the ground plane is a first type of antenna element, and further comprising attaching a second type of antenna element to the ground plane, wherein one of the two lanes is located between said first type of antenna element and the second type of antenna element.

14. The method as recited in claim 8 wherein the at least one antenna element includes two dual slant polarization dipole antenna elements, and the antenna element connected to the elevated grounding surface is one of two tripole antenna elements each of which is connected to the elevated grounding surface at an intersection of the third lane and one of the two lanes.

15. A base station antenna, comprising:
an antenna ground plane;
one or more sub-antenna arrays each comprising a plurality of a first type of antenna element attached to the ground plane; and
a spatial diplexer sub-antenna, including:
a pedestal that is coupled to the antenna ground plane adjacent the one or more sub-antenna arrays and having an elevated grounding surface including two lanes, and
a sub-antenna array comprising a plurality of a second type of antenna element attached to the antenna ground plane between the two lanes, and
a sub-antenna array comprising a plurality of a third type of antenna element attached to the elevated grounding surface, each of two of the third type of antenna element being located at a corresponding intersection of the two elevated grounding surface lanes and a third elevated grounding surface lane.

16. The antenna as recited in claim 15 wherein the third elevated grounding surface lane is about perpendicular to the two elevated grounding surface lanes.

17. The antenna as recited in claim 15 wherein the third elevated grounding surface lane includes a widened elevated grounding surface between the two elevated grounding surface lanes.

18. The antenna as recited in claim 15 wherein the third elevated grounding surface lane is positioned midway between two of the second type of antenna elements.

19. The antenna as recited in claim 15 wherein a distance between the elevated grounding surface and the ground plane is in a range of about 12 percent to about 18 percent of a separation distance between the two third type of antenna elements.

20. The antenna as recited in claim 15 wherein the first type of antenna element is a high-band dipole, the second type of antenna element is a low-band dipole, and the third type of antenna element is a low-band tripole.
